(19) United States
(12) Patent Application Publication
(10) Pub. No.: US 2006/0159999 A1
(43) Pub. Date: Jul. 20, 2006

(54) Method of automated prismatic electrochemical cells production and method of the cell assembly and construction

(76) Inventors: Joseph B. Kejha, Meadowbrook, PA (US); David Chua, Wayne, PA (US); Hsiu-Ping Lin, Princeton, NJ (US)

Correspondence Address: JOSEPH B. KEJHA, 1022 FREDERICK RD., MEADOWBROOK, PA, 19046, US

(21) Appl. No.: 11/378,973

(22) Filed: Mar. 18, 2006

Related U.S. Application Data
(63) Continuation-in-part of application No. 10/119,220, filed on Apr. 9, 2002.
Application No. 10/119,220 is a continuation-in-part of application No. 09/911,036, filed on Jul. 23, 2001.

(51) Int. Cl. H01M 2/16; H01M 10/04; H01M 4/58; H01M 4/62; H01G 9/02

(52) U.S. Cl. 429/254; 29/623.4; 29/623.5; 429/231.8; 429/217; 361/503

(57) ABSTRACT

The present invention pertains to electrochemical devices having a thin micro porous polytetrafluoroethylene separator bonded to their porous electrodes without special treatment of the separator and without additional adhesive layers. Structures of superior high energy density and power density are disclosed herein, as well as the methods of their assembly and automated production.

### CROSS REFERENCE TO RELATED DOCUMENTS

This Application is a continuation in part of the Application of Joseph B. Kejha at al., Ser. No. 10/119/220 filed on Apr. 9, 2002, and entitled “Method of Automated Hybrid Lithium-Ion Cells Production and Method of the Cell Assembly and Construction”, which is a continuation in part of the application of Joseph B. Kejha at al. Ser. No. 09/911,036, filed Jul. 23, 2001 and entitled “Manufacturing Method and Structure of Electrodes for Lithium-Based El. Chemical Devices. The subject matter of the invention is shown and described in the Disclosure Document of Joseph B. Kejha, Ser. No. 490,145 filed on Mar. 8, 2001, and entitled “Automated Lithium-Polymer Cells Production and Method of Cell Assembly and Construction.”, and in the Disclosure Document of Joseph B. Kejha, Ser. No. 583,446 filed on Aug. 2, 2005 and entitled “Improved Prismatic Capacitors, Ultracapacitors and Lead-Polymer Cells, their Hybrids and Low Cost Assembly Method.”

### BACKGROUND OF THE INVENTION

1. Field of the Invention

This invention pertains mostly to automated production, assembly and construction of prismatic electrochemical devices, such as lithium-ion batteries, non-aqueous capacitors, and aqueous batteries and capacitors, and more specifically the devices which have a microporous polytetrafluoroethylene polymer film separator adhesively joined to the electrodes, and used as a carrier of the cells through the assembly process.

2. Description of the Prior Art

Prior art lithium polymer cells and their plasticized electrodes are usually heat welded (laminated) together by a plasticized PVDF polymer film separator sandwiched therebetween as described in the U.S. Pat. No. 5,587,253 of Gozdz et al. This separator is too soft and must be thick to prevent shorts, which decreases the energy density. Another method employs a thin, specially treated polypropylene or polyethylene micro porous Celgard separator as is disclosed in the U.S. Pat. No. 6,322,923B1 of Spotnitz et al., which is pre-coated by a layer of plasticized polyvinylidene fluoride hexafluoropropylene (PVDF/HFP) copolymer by propylene carbonate (PC). The treated Celgard separator is then similarly heat welded (laminated) to the plasticized electrodes, as is disclosed in the U.S. Pat. No. 6,328,770B1. The preferred “plasticizer” is really PVDF-HFP latent solvent, PC. In both methods, the plasticizer must be then extracted by a flammable non-solvent bath of the cells.

Another cell assembly method and structure of Yoshida et al., as described in the U.S. Pat. No. 6,291,102B1 employs coating of the Celgard separator on both sides or the electrodes with a polymeric adhesive, which then holds the cell together. A similar method is also described in the U.S. Pat. No. 6,692,543B1 of Hamano et al. However, all these methods add a thickness to the cell due to additional layers, and partially close, or restrict the separator pores, which increase the cell resistance, and decrease the energy density.

All the cells are then vacuum dried, soaked by a liquid non-aqueous electrolyte, and sealed in a lightweight and soft, moisture-proof pouch.

The entire prior art methods above are very labor intensive with many steps, and therefore costly. The liquid electrolyte lithium-ion prismatic, or rolled cell, or capacitor comprises non-plasticized (dry) electrodes coated on solid metal foils and a Celgard microporous polymer separator, stacked or rolled between them, but not bonded or glued.

Whole cell assembly is held together only by a sealed hard casing, and the cell is also soaked by an electrolyte.

The hard casings are usually heavy and the prismatic battery cells or capacitors have size limitations, due to limited stiffness of the casing and its ability to maintain pressure on the stack. The heavy casing decreases the energy density. The solid metal foil current collectors seal the surface of the electrodes and restrict soaking of the cell by the electrolyte, and the soaking must be therefore done under vacuum, which is costly.

Example is the Maxwell prismatic ultracapacitor. Also lead-acid batteries, such as Panasonic lead-acid gelled prismatic batteries have stacked thick electrode plates, which assembly is difficult to automate.

Automated production of liquid electrolyte prismatic, or rolled electrochemical devices requires complex and expensive robotic machinery for handling of the loose components and assemblies. Prior art automated lithium polymer electrochemical devices production methods utilize the first electrode length and the plasticized solid polymer separator film length as a carrier of the cells through the assembly process. The prior art solid polymer separator length may have also a composite structure, having embedded-in various nets, as shown in the U.S. Pat. No. 5,102,752, or the separator may be coated on one of the electrodes and then is partially solidified. The second electrode, cut into spaced leafs is then added and the separator is then fully solidified. In the above examples, the polymer of the separator is used as the adhesive, which holds the cells together after the solidification, or the plasticized free film separator is fully solidified, and then heat welded to the electrodes in between the second electrode leafs.

Prior art lithium polymer cells production methods and cell structures require, or result in having a relatively thick separator, due to the soft polymer, non-uniform coating, and/or thick net, which decreases the energy density of the cells, and makes them thus non-competitive in this respect with the liquid electrolyte prismatic cells having thin and tough Celgard separator. However, the non-welded prismatic and rolled cells have heavy casings. To overcome these disadvantages and mainly to provide a thermal shut down capability, a flat bonded cell structure having a polyolefin separator is proposed in the U.S. Patent of Gozdz et al. U.S. Pat. No. 6,391,069B1 and in the U.S. Patent of Gozdz U.S. Pat. No. 6,413,667B1. Both patents utilize the plasticized polymeric matrix of the electrodes for bonding the electrodes to the polyolefin separator, and both patents are limited to using only polyolefin separators, due to their thermal shut-down feature for the described safety reason. The polyolefin separator melts and closes the pores when overheated by a cell short, which stops the cell to function. However, it has been found that the thermal shut down feature is undesirable because it causes a catastrophic battery failure, when the cells are connected in series. The shut down cell in the string of cells goes into a voltage reversal, overcharges and explodes. The safety is better served by a more heat resistant polymeric separator such as Teflon, (which is not a polyolefin, but fluorocarbon which does not melt), and by redundant electronic controls of any multi-celled electrochemical device, including ultracapacitors and aqueous batteries. The methods of assembly and resulting cells' structures in the above patents are different from the instant invention.

Therefore, the “ideal electrochemical cell” is of hybrid construction, in which the porous electrodes are adhesively joined with an ultra-thin, microporous, tough and dry, heat resistant separator, without adding a thickness to the cell, and which cell therefore does not require a heavy hard casing, can be easily activated by an electrolyte without the use of vacuum, and may be packaged in a lightweight pouch. The hybrid cells construction, and the method of their easily automated production of this invention, combine only the best features of the polymer cells and the liquid electrolyte cells, but do not suffer from prior art problems and provide superior energy density, heat resistance and many other positive advantages.

### SUMMARY OF THE INVENTION

It has now been found, that a lithium-ion polymer cell, capacitor, or other electrochemical chemical devices including aqueous cells can be made by bonding their electrodes to a heat resistant microporous, polytetrafluoroethylene (PTFE), tough and thin film separator without the separator special treatment or polymer pre-coating, or without using a polymeric adhesive layer(s). The preferred separator is made of Teflon PTFE, Gore Excellerator, as manufactured by W. L. Gore and Associates, Inc., Elkton, Md., but the invention is not limited only to this separator and polymer type. Similar PTFE products made by Goretex Inc. in Japan and others are also suitable, and other heat resistant polymers, such as Kapton polyimides are suitable. It has been found, that the adhesion of the electrodes to the separator is caused by welding or bonding the polymeric binder of the electrodes directly to the dry PTFE separator surface, which is a surprising finding, because supposedly “nothing sticks to the Teflon”. Therefore, no additional layer(s) or thickness is added, or is necessary to the cell laminate. The preferred binder of the electrodes is polyvinylidene fluoride (PVDF) homopolymer, or a PVDF copolymer. These binders adhere to the polytetrafluoroethylene, or other polymer microporous separator even if they are of dissimilar polymers. Other polymeric binders are also useable. The principle of this invention is to use any binder of the electrodes or in the electrodes structure to bond also the electrodes to the PTFE separator.

The preferred electrodes are non-plasticized, porous (dry) electrodes, coated on porous, expanded metal foil, or solid foil, as described in our prior patent application Ser. No. 09/911,036, which is herein incorporated by reference.

To promote adhesion to the hard and dry non-plasticized electrodes, the electrodes are lightly soaked or sprayed prior to weld (laminating) by a high boiling point aprotic liquid such as butylene carbonate, gamma-butyrolactone, ethylene carbonate, N-methyl pyrrolidinone, and various glycols preferably having boiling point about or less then 240° C., tetraglyme, or their mixtures.

All the above aprotic liquids are harmless to the cell electrolyte or chemistry, if traces of them are left in the cell.

The function of the aprotic liquid in the electrodes is to lower the melting point of the electrodes binder at the interfaces with the separator.

The heat welding temperature of the laminating step should be set higher than the melting point of the binder of the electrodes, but lower than the decomposition point of the PTFE separator. There is a great advantage in using PTFE separator, due to its heat resistance which prevents collapsing and closing of the pores. It has been found that in the automated cells production, the described microporous separators may be used as the cells carrier through the assembly process.

The separator may be horizontally fed into nip-rollers of a horizontal laminator with top and bottom heat plates and a pair of pressure rollers.

Two single cells' electrodes may be simultaneously cut into leafs and fed into the same nip-rollers in a synchronized manner, so they line up on top and bottom of the separator, with a lengthwise space between them. Whole assembly may be then laminated by preheating it in the heat plates and then welding it together by preferably compliant pressure rollers, having preferably a steel roller on the bottom and a rubber roller on the top.

On the top and bottom of the electrodes are also release films or papers, or belts fed through the same nip-rollers, plates and pressure rollers, to carry the bottom electrodes and to prevent a misalignment of the electrodes, while traveling through the laminator heat plates. These release films maybe also arranged as endless belts, or maybe “spool to spool” unwinded and winded. The laminated single cells assembly length may be then wound onto a spool, or cut between the cells into individual cells and stacked, or several cells may be “Z” folded by bending the separator only in the linear spaces between the cells, and then cut between the cell packs. Similarly, an automated bi-cells production can be made by feeding the single cells assembly length from the spool, for the second time through the laminator and by feeding on the top of the single cells' second electrodes the second porous separator, and cutting and feeding third electrode leafs into the nip-rollers in a synchronized manner, so they line up with the single cells' second electrodes, and then weld-laminating them together.

The resulting laminated bi-cell assembly length may be then similarly cut or folded as described for single cells production.

The laminated single or bi-cells, single or bi-cell packs, or other electrochemical devices, may be then vacuum dried, inserted under inert atmosphere into thin and lightweight moisture proof pouches or casings, activated by a liquid electrolyte, and sealed.

The principal object of this invention is to provide a more reliable electrochemical cell construction, which has a superior energy density, power density, heat resistance and easier automated assembly over the prior art.

Another object of this invention is to provide simpler, less costly, automated production method of electrochemical devices over the prior art.

Other objects and advantages of the invention will be apparent from the description and claims.

### BRIEF DESCRIPTION OF THE DRAWINGS

The nature and charactistic features of the invention will be more readily understood from the following descriptions taken in connection with the accompany drawing forming part hereof in which:

FIG. 1 is a diagrammatic, side elevational, sectional view of the singe cell, illustrating its components and their layers.

FIG. 2 is a top elevational view of the single cell, illustrating terminal tabs, electrodes and separator sizing, and their overlying relationship.

FIG. 3 is a diagrammatic, side elevational, sectional view of the bi-cell, illustrating its components and their layers.

FIG. 4 is a top elevational view of the bi-cell, illustrating terminal tabs, electrodes and separator sizing, and their overlying relationship.

FIG. 5 is a diagrammatic, side elevational view of the single cell assembly machine, illustrating its various components and their locations.

FIG. 6 is a diagrammatic, side elevational view of the bi-cell assembly machine, illustrating its various components and their locations.

Like numerals refer to like parts throughout the several views and figures. It should, of course, be understood that the description and the drawings herein are merely illustrative, and it will be apparent that various modifications, combinations and changes can be made of the structures and the systems disclosed without departing from the spirit of the invention and from the scope of the appended claims.

### DESCRIPTION OF THE PREFERRED EMBODIMENTS

When referring to the preferred embodiments, certain terminology will be utilized for the sake of clarity. Use of such terminology is intended to encompass not only the described embodiment, but also all technical equivalents which operate and function in substantially the same way to bring about the same results.

Prismatic electrochemical devices and for example lithium-ion-polymer prismatic battery cell usually comprises two flat electrodes, each with metal foil current collectors on the outside, and a polymer electrolyte separator between the electrodes. The separator is in the polymer type cell welded or adhesively joined to both electrodes and holds the cell together.

The present invention employs a novel cell structure and a simpler and more reliable method for manufacturing of the cells, which structure and method result in improved cells with many advantages.

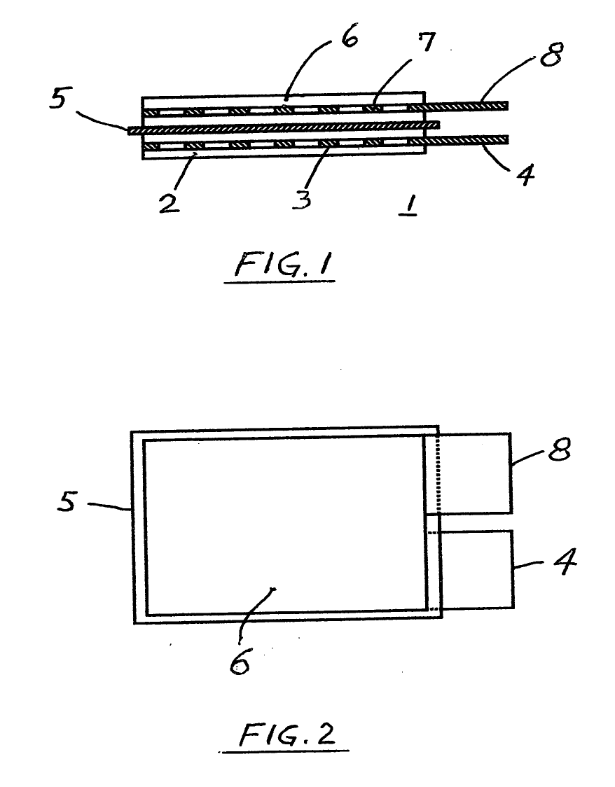

Referring now in more detail, particularly to the drawings of this patent and FIGS. 1 and 2, one embodiment of this invention is the lithium-ion polymer single cell 1 comprising: The first electrode layer 2 which may be an anode, having embedded in porous copper grid current collector 3 with a terminal tab 4; ½ mil thin microporous PTFE separator layer 5, which is dry, untreated polytetrafluoroethylene, such as manufactured by W. L. Gore and Associates, Elkton, Md., and the second electrode layer 6, which may be a cathode, having embedded-in a porous aluminum grid current collector 7 with a terminal tab 8.

The separator 5 is simply heat welded or bonded (laminated) in one step by a controlled heat and pressure roller laminator, or a controlled hot press with compliant plates (not shown), directly to the surfaces of the electrodes 2 and 6, without any special separator surface treatment, or pre-coating with polymeric adhesive layers.

The preferred separator is Gore Excellerator made of Teflon polytetrafluoroethylene (PTFE), but the invention is not limited only to this separator type. Other porous heat resistant PTFE are also suitable, such as PTFE separators made by other manufactures like Goretex, Inc. in Japan and others, as is described in our prior application Ser. No. 10/119,220. (Goretex, Inc. made and makes only the PTFE separators). Multi-layer, multi-polymer separators are also useable, when having at least one microporous polytetrafluoroethylene layer facing the electrodes. The adhesion is achieved only by the polymeric binder of the electrodes, which melts under the laminating heat and pressure, and re-solidifies, and bonds to the PTFE separator by subsequent cooling to room temperature. Therefore, no additional layers or thickness is/are added to the cell, or are necessary.

The preferred binder of the electrodes is polyvinylidene fluoride (PVDF) homopolymer, or a polyvinylidene fluoride copolymer. These binders adhere to the PTFE or other porous polymer separator even if they are dissimilar polymers. Other polymeric binders may be also suitable. This adhesion is a surprising discovery, because supposedly “nothing sticks to the Teflon”. The principle of the invention is to use any binder of electrodes and/or in the electrodes to bond also the electrodes to the PTFE separator. This separator is thinner than polyolefin separators, (which also lowers the resistance and improves energy density), due to its strength and toughness. The preferred electrodes are non-plasticized, porous (dry) electrodes, having porous expanded or solid metal foil current collectors and a PVDF based binder, as described in our prior patent application Ser. No. 09/911,036, which is herein incorporated by reference. Because these electrodes are not plasticized, they can be more loaded with active materials for high energy density.

In a single cell—at least one electrode should have the porous metal current collector, and in a bi-cell—at least two electrodes should have the porous metal current collectors, to facilitate easy drying and activation by a liquid electrolyte.

To promote adhesion to the hard and dry non-plasticized electrodes, the electrodes are lightly soaked or sprayed prior to welding or bonding (laminating) by a high boiling point aprotic liquid, which is later dried out after the cell welding or bonding, by drying and/or heating the cell in a vacuum chamber (not shown).

The preferred high boiling point aprotic liquids are butylenes carbonate, gamma-butyrolactone, ethylene carbonate, N-methyl polyrolidinone, various glycols preferably having boiling point about or less then 240° C. tetraglyme, or their mixtures. The reason why aprotic liquids are used is because the above aprotic liquids are harmless to the cell electrolyte or chemistry if small amounts or traces of them are left in the cell.

The function of the aprotic liquid is to lower the melting point of the electrode's binder at the interfaces, with the separator. Since Teflon separator is very heat resistant, it doesn't melt and maintains its porosity. The heat welding or bonding temperature of the laminating step should be set slightly higher than melting point of the electrode binders, but never higher than the decomposition temperature of the PTFE separator. Due to the large difference in these temperatures, the cell of the invention is much more easily bonded together, than the cells having polyolefin separator, which have a narrow window between the melting points of PVDF and polyolefins.

Similarly, other electrochemical devices, such as capacitors, ultracapacitors (aqueous and non-aqueous) and aqueous battery cells can be assembled by the same bonding method and having the microporous PTFE separator bonded to the electrodes of various active materials.

### EXAMPLE #1 (NON-AQUEOUS BATTERY SINGLE CELL PREPARATION)

a. Several cathode current collectors were cut into section from aluminum expanded micro grid (Exmet Corp.), and surface treated by well known electrically conductive coating(Acheson EB-012). Cathode slurry of desired viscosity with PVDF homo polymer binder and without any plasticizer was prepared according to the same patent application, containing LiCoO2 as the active material, and a carbon. The current collectors were partially, vertically hand dipped into the slurry, then slowly pulled upward, suspended on a rack, and then vacuum dried in vacuum oven at approximately 100° C. for 2 hours.

b. Similarly, several anode current collectors were cut into sections from copper expanded micro grid (Exmet Corp.), surface treated, as described in our patent application Ser. No. 09/911,036, identically hand dip coated by anode slurry of desired viscosity and without any plasticizer, containing mesocarbon microbeads (MCMB) as the active material, a carbon, and PVDF homo polymer as the binder, suspended and similarly vacuum dried.

c. All the above electrodes were then cut into the same size sections, (having uncoated terminal tables as shown in FIG. 2), weighed, marked and kept in separate anode and cathode groups.

d. Untreated dry Gore Excellerator microporous 12 microns thin PTFE separator (as sold for use in liquid non-aqueous electrolyte cells by W. L. Gore & Associates, Inc.) was cut into a section slightly larger in lateral dimensions than the electrodes.

e. One anode and one matching cathode electrodes were selected for the cell assembly from their groups, based on their substantially similar capacities, calculated from their active material weights.

f. Both electrodes were inserted into silicone release paper folders and hot calendared by a commercial goldsmith's roller press, to reduce their thickness by about 10-30%.

g. Both the electrodes were lightly soaked by butylenes carbonate with a brush, and micro porous separator from the step “d”, was then sandwiched between the electrodes in overlying relation, as shown in FIGS. 1 and 2, and whole assembly was inserted into a folder of polyester films and fed into a commercial, heated, compliant pressure roller laminator, set to about 130° C.-150° C. temperature, which welded and/or bonded the cell assembly together, without damaging the separator.

h. The resulting cell was then placed for 2 hours into a vacuum oven, set at about 45° C. temperature, to dry out the aprotic liquid and then the cell was dried under approx. 30″ Hg vacuum at room temperature for 8 hours, before activation under inert atmosphere by well known liquid electrolyte containing, 1 Mole LiPF₆ salt, ant heat sealing in a plastic coated metal foil pouch, with sealed terminal tabs protruding out from the pouch. The cell was rechargeable and cycled between 3.0V to 4.2V.

### EXAMPLE #2 (NON-AGUEOUS BATTERY SINGLE CELL PREPARATION)

a. Metal microgrids of both electrodes, as described in the Example #1 were identically cut, treated and dip-coated, except at this time by well known plasticized active materials slurries of desired viscosity with PVDF/HFP binder as described in prior art patents, but the slurries contained propylene carbonate (PC) instead of the conventional dibutyl phalate (DBP). The coated grids were suspended and dried in air at room temperature, cut into identical sections, and calendared, as described in the Example #1.

b. Untreated, dry Gore Excellerator microporous PTFE separator, as described in the Example #1, step “d” was identically prepared.

c. The separator from the step “b” of this Example #2 was sandwiched between the plasticized, matching electrodes in overlying relation, as shown in FIGS. 1 and 2, and was heat welded and/or bonded to the electrodes, similarly as described in the Example #1, and without damaging the separator.

d. The resulting cell was then placed into (3) consecutive extraction baths of ethanol for ½ hour each, which extracted the propylene carbonate. The cell was then dried under 30″ Hg vacuum at room temperature for 8 hours, before the same activation and packaging, as described in the Example #1, and was rechargeable and cycled between 3.0V-4.2V.

### EXAMPLE #3 (ULTRACAPACITOR SINGLE CELL PREPARATION)

a. Several electrodes' current collectors were cut into sections from aluminum expanded micro grid (Exmet Corp.) and surface treated by well known electrically conductive coating as manufactured by Acheson. Electrodes' active coating slurry of desired viscosity with PVDF homo polymer binder and without any plasticizer was prepared as described in our patent application Ser. No. 09/911,036 for anode, except the MCMBs of the same % WT. were replaced by activated carbon obtained from TDA Research, Inc. The current collectors were partially, vertically hand dipped into the slurry, then slowly pulled upward, suspended on a rack and then vacuum dried for 2 hours.

b. All above electrodes were then cut into the same size section, (having uncoated terminal tabs as shown in FIG. 2), weighed and marked and kept in a group.

c. Untreated, dry Gore Excellerator, microporous 12 microns thin PTFE separator (as sold for use in liquid non-aqueous electrolyte cells by W. L. Gore & Assoc., Inc.) was cut into a section slightly longer in lateral dimensions then the electrodes.

d. Two matching electrodes were selected for the cell assembly from the group (step “b”), based on the substantially similar weight of their active materials.

e. Both electrodes were inserted into silicone release paper folders and hot calendared by commercial pressure roller laminator to reduce their thickness by approx. 10%.

f. Both electrodes were lightly soaked by butylene carbonate with a brush, and the dry microporous separator from the step “c”, was then sandwiched between the electrodes in overlying relation, as shown in FIGS. 1 and 2, and whole assembly was inserted into a folder of polyester films and fed into a commercial, heated, compliant pressure roller laminator, set to about 130° C.-150° C. temperature, which welded and/or bonded the cell assembly together, without damaging the separator.

g. The resulting cell was then placed for 2 hours into a vacuum oven, set at about 45° C. temperature, to dry out the aprotic liquid, and then the cell was dried under approx. 30″ Hg vacuum at room temperature for 8 hours, before activation under inert atmosphere by a well known electrolyte containing tetraethylammonium-tetrafluroborate salt in acetonitrile (AN) and sealing in a plastic coated metal foil pouch, with sealed terminal tabs protruding out from the pouch. This ultracapacitor cell was cycled between 0.0 V to 2.7 V, and was highly rechargeable.

### EXAMPLE #4 (AQUEOUS BATTERY SINGLE CELL PREPARATION)

a. Several cathode current collectors were cut into sections from lead expanded micro grid (Exmet Corp.), and surface treated as described in our patent application Ser. No. 09/911,036 for the copper grid (PVDF based treatment). Cathode slurry of desired viscosity with PVDF homo polymer binder and without any plasticizers was prepared according to the same Patent Application, except the active material LiCoO₂ was replaced by the well known lead oxide, such as used in lead batteries for cathodes. The current collectors were partially vertically hand dipped into the slurry, then slowly pulled upward, suspended on a rack, and then vacuum dried for 2 hours.

b. Similarly, several anode current collectors of lead expanded micro grids were identically cut and treated as described in the step “a” above, and identically dip-coated, but this time by the anode slurry of desired viscosity, having PVDF homopolymer binder without any plasticizers, and prepared according to the same Patent Application for the anode, except the MCMBs of the same % WT. were replaced by the well known leady-lead oxide, such as used in lead batteries for anodes.

c. All above electrodes were then cut into the same size sections, (having uncoated terminal tabs as shown in FIG. 2), weighed, marked and kept in separate anode and cathode groups.

d. Untreated, dry Gore Excellerator micro porous 25 micron thin PTFE separator (as sold for use in liquid aqueous electrolyte cells by W. L. Gore and Assoc., Inc.) was cut into a section slightly larger in lateral dimensions than the electrodes.

e. One anode and one matching cathode electrodes were selected for the cell assembly from their groups, based on their substantially similar capacities, calculated from their active material weights.

f. Both electrodes were inserted into silicone release paper folders and hot calendared by a commercial goldsmith's roller press, to reduce their thickness by about 10-30%.

g. Both electrodes were lightly soaked by butylenes carbonate with a brush, and the dry, microporous separator from the step “d”, was then sandwiched between the electrodes in overlying relation, as shown in FIGS. 1 and 2, and whole assembly was inserted into a folder of polyester films and fed into a commercial, heated compliant pressure roller laminator, set to about 130° C.-150° C. temperature, which welded and/or bonded the cell assembly together, without damaging the separator.

h. The resulting cell was then placed for 2 hours into a vacuum oven, set at about 45° C. temperature, to dry out the aprotic liquid and then the cell was dried under approx. 30″ Hg vacuum at room temperature for 8 hours, before activation under air atmosphere by a well known aqueous electrolyte containing sulphuric and/or phosphoric acid in water, and heat sealing in a plastic pouch. The cell was rechargeable and cycled between 1.7 V to 2.0 V. This kind of bonded cell may be referred to as “lead-polymer battery”.

Similarly, an aqueous ultracapacitor can be made, having both electrodes of activated carbon and acid based aqueous electrolyte, and furthermore—an asymmetric aqueous ultracapacitor in can be similarly made, having one electrode with lead oxide, second electrode with activated carbon, and an acid based electrolyte. Also, a non-aqueous asymmetric capacitor can be made similar to Example #3, except one electrode may have the active material of a lithium oxide, such as lithium titanate and an AN-based electrolyte containing a lithium salt, such as LiBF4, instead of the tetraethylammonium-tetrafluoroborate salt.

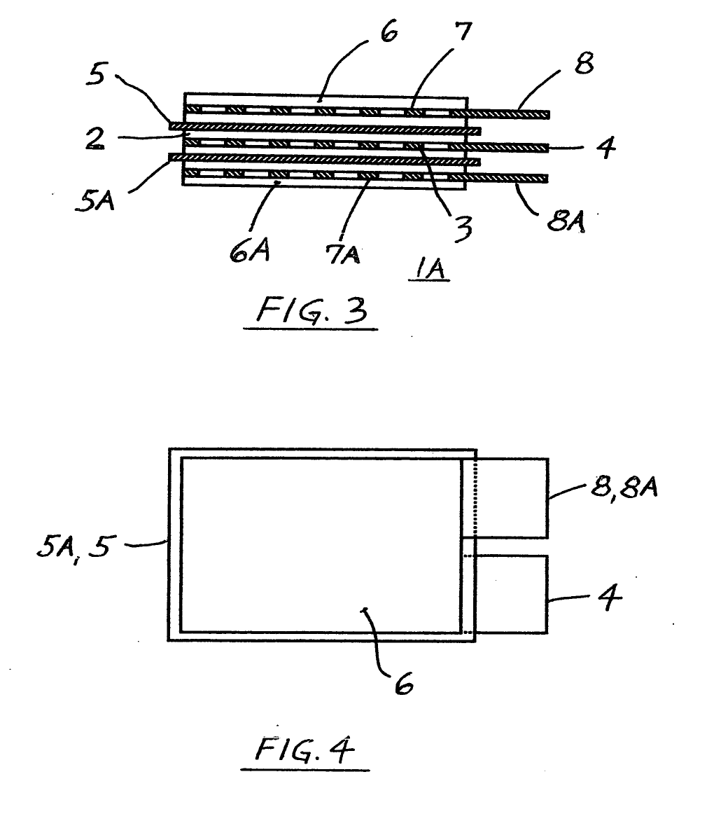

Another embodiment of the invention is illustrated in FIGS. 3 and 4, showing the hybrid lithium-ion polymer bi-cell 1A comprising: The first electrode layer 2, which may be an anode, having embedded-in the middle a porous copper perforated foil current collector, or a solid copper foil current collector 3 with the terminal tab 4; the first ½ mil thin and microporous PTFE separator 5, the same separator as described in the single cell; the second electrode layer 6, which may be a cathode having embedded-in a porous aluminum grid current collector 7 and the terminal tab 8; the second porous polymer separator layer 5A, identical to the described separator layer 5; and the third electrode layer 6A, which may be the second cathode, identical to the layer 6, having embedded-in a porous aluminum grid current collector 7A with terminal tab 8A.

This bi-cell may be similarly prepared and heat welded or bonded (laminated) together in one or two steps, like is described for the single cell 1 above, while using the same materials, methods, and tools.

Similarly, a stacked muti cell, multilayer electrochemical device can be bonded together, having at least two electrodes and at least one microporous PTFE separator, but the electrodes and the separators may be in virtually unlimited numbers. A hot press with compliant plates may be used for said bonding.

The advantage of the bi-cell is in having only one anode current collector 3, which reduces the total weight per capacity, and thus results in a higher energy density than of the single cell. However, both cells of the invention have higher energy density and rate capability over the prior art polymer cells or liquid electrolyte cells, due to their thinner separator, lesser total thickness, lightweight enclosure, and due to having the metal grid current collectors embedded in the middle of their electrodes by dip coating, as described in our prior patent application Ser. No. 09/911,036.

It should be noted that for other electrochemical devices, the current collectors' metals should be selected to be compatible with the particular cell chemistry and voltage.

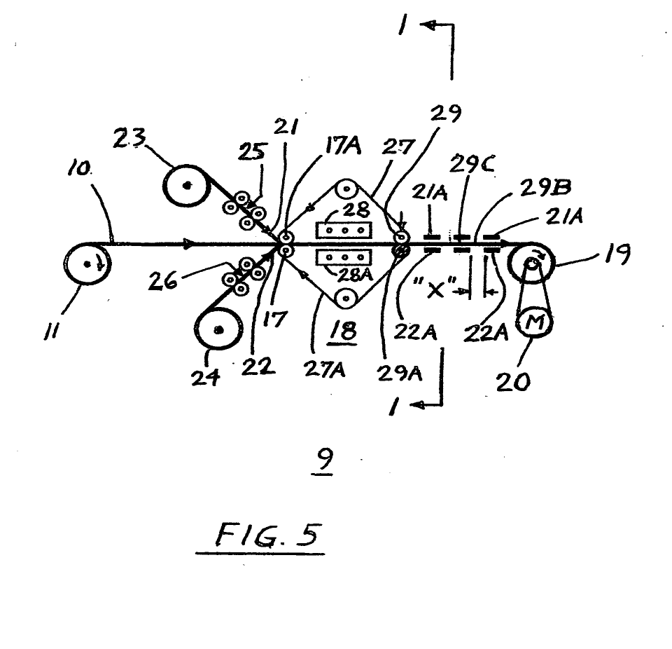

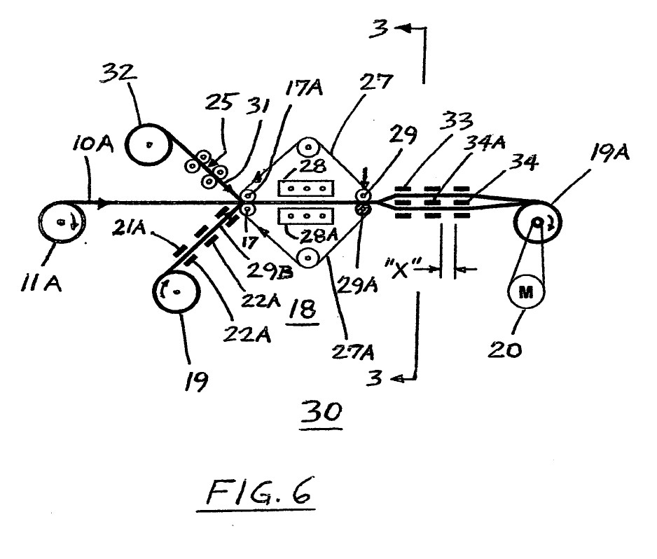

Referring now to FIG. 5; illustrating the automated single cells assembly machine 9 and the method of the automated hybrid single cells production, which is another embodiment of the invention.

The microporous PTFE, dry, untreated separator length 10 is used as the cells carrier through the assembly process, in which the separator length 10 is unwound from the spool 11 and the separator length 10 is then fed into the nip-rollers 17 and 17A of the heat and pressure roller type laminator 18, pulled through by and wound onto spool 19, driven by motor 20. The single cell's electrodes' lengths anode 21, and cathode 22, lightly pre-soaked by an aprotic liquid may be unwound from the spools 23 and 24, through the metering cutters 25 and 26, such as used in photo processing, and maybe simultaneously cut into the leafs 21A and 22A and fed into the same nip-rollers 17 and 17A in a synchronized manner, so they line up on top and bottom of the separator length 10 with a lengthwise spaces “X” between them. On top and bottom the electrodes' leafs 21A and 22A are also release films, or papers, or endless belts 27 and 27A fed into nip-rollers 17 and 17A, heat plates 28 and 28A, and pressure rollers 29 and 29A, to carry the bottom electrodes 22A and to prevent a misalignment of the electrodes, while traveling through the heat plates 28 and 28A. These release films maybe arranged as endless belts, or may be “spool to spool” unwound and wound (not shown). Whole cell's assembly length 29B is laminated by preheating it in the heat plates 28 and 28A and then welding or bonding it together by the compliant pressure rollers 29 and 29A. The roller 29A may be preferably made of steel and the roller 29 may be preferably having a rubber surface. The pressure may be achieved by air-springs or by other means. The laminated single cells assembly length 29B may be then wound onto the spool 19, or may be cut (in spaces “x”) into individual cells and stacked into cell packs, or several cells may be “Z” folded in the linear spaces “x” between the cells, and then cut between the cell packs (not shown). The laminator 18 may have also a separate drive motor (not shown), for driving nip-rollers 17 and 17A and pressure rollers 29 and 29A, either synchronized with the motor 20, or the motor 20 may have an overdrive with a slip clutch (not shown).

In the sectional view “1-1”, the single cell 29C looks like the cell 1 in FIG. 1. It should be noted that the tabs 4 and 8 as shown in FIG. 2 may be cut, or notched-out on an automatic notcher prior to feeding the electrodes 21 and 22 into the cutter 25 and 26.

Referring now to FIG. 6, illustrating the automated bi-cells assembly machine 30 and the method of the automated hybrid bi-cells production, which is another embodiment of the invention.

Similarly, the single cells assembly length 29B may be fed from the spool 19 for the second time through the laminator 18 and the second microporous PTFE, dry, untreated separator length 10A may be fed onto the nip-rollers 17 and 17A on the top of the single cell's anodes 21A, and the third electrode (such as the second cathode) length 31, may be lightly pre-soaked by an aprotic liquid, unwound from the spool 32, fed through the metering cutter 25 and may be cut into the leafs 33 and fed into the same nip-rollers 17 and 17A in a synchronized manner, so they line up with the single cell's anodes 21A, and bond them all together. The resulting laminated bi-cells assembly length 34 may be similarly wound onto the spool 19A, or cut into individual bi-cells 34A, which may be stacked into bi-cell packs, or “Z” folded, as described for the single cells production. In the sectional view “3-3”, the bi-cells 34A looks like the bi-cell 1A in FIG. 3. The terminal tabs 8A, as shown in FIG. 4 may be also notched out prior to feeding the electrode 31 into the cutter 25.

Of course, the bi-cell assembly can be also reversed, having the cathode in the middle and two anodes on the outsides, and may be similarly automatically or manually assembled and weld-laminated or bonded together. Similarly, additional layers may be also added and bonded.

The laminated single cells or bi-cells, or single or bi-cell packs, capacitors, or other electrochemical devices may be then electronically connected, vacuum dried, to dry out the aprotic liquid and moisture, and inserted under an inert atmosphere (if applicable) into thin walled and lightweight pouches or casings, activated by appropriate liquid electrolyte, and sealed.

It should, of course, be understood that the description and the drawings herein are merely illustrative and it will be apparent that various modifications, combinations and changes can be made of the structures and the systems disclosed without departing from the spirit of the invention and from the scope of the appended claims.

It will thus be seen that a more economical and reliable method for electrochemical devices manufacturing, and improved cells' structures have been provided with which the objects of the invention are achieved.

We claim:

1. A manufacturing method of prismatic single cell electrochemical device comprising the steps of:
providing a first dry porous electrode structure then soaked with an aprotic liquid and having an active material with a carbon and a polymeric binder coated on both sides of a porous metal current collector;
providing a second dry porous electrode structure then soaked with an aprotic liquid and having an active material with a carbon and a polymeric binder coated on both sides of a porous metal current collector;
providing a dry, untreated microporous polytetrafluoroethylene separator;
bonding said separator between said first electrode structure and said second electrode structure by said binders of said electrodes by applying heat and pressure and cooling said device;
and drying out said aprotic liquid.

2. A manufacturing method of prismatic bi-cell electrochemical device comprising the steps of:
providing a first dry porous electrode structure then soaked with an aprotic liquid and having an active material with carbon and a polymeric binder coated on both sides of a porous metal current collector;
providing a second dry porous electrode structure then soaked with an aprotic liquid and having an active material with a carbon and a polymeric binder coated on both sides of a porous metal current collector;
providing a third dry porous electrode structure then soaked with an aprotic liquid and having an active material with a carbon and a polymeric binder coated on both sides of a porous metal current collector;
providing a first dry, untreated, microporous polytetrafluoroethylene separator;
providing a second dry, untreated, microporous polytetrafluoroethylene separator;
bonding said first separator between said first electrode structure and said second electrode structure, and said second separator between said second electrode structure and said third electrode structure by said binders of said electrodes by applying heat and pressure and cooling said device;
and drying out said aprotic liquids.

3. A manufacturing method of prismatic bi-cell electrochemical device comprising the steps of:
providing a first dry porous electrode structure then soaked with an aprotic liquid and having an active material with a carbon and a polymeric binder coated on both sides of a porous metal current collector;
proving a second dry porous electrode structure then soaked with an aprotic liquid and having an active material with carbon and a polymeric binder coated on both sides of a solid metal foil current collector;
providing a third dry porous electrode structure then soaked with an aprotic liquid and having an active material with a carbon and a polymeric binder coated on both sides of a porous metal current collector;
providing a first dry, untreated, microporous polytetrafluoroethylene separator;
providing a second dry, untreated, microporous polytetrafluoroethylene separator;
bonding said first separator between said first electrode structures and said second electrode structure, and said second separator between said second electrode structures and said third electrode structure by said binders of said electrodes by applying heat and pressure and cooling said device;
and drying out said aprotic liquid.

4. A structure of prismatic electrochemical device comprising at least two prismatic porous electrodes having an active material with a carbon and a polymeric binder coated on both sides of porous metal current collectors of said electrodes; and at least one prismatic microporous polytetrafluoroethylene separator bonded between said electrodes by said binders of said electrodes, and in which said binders and said separator are of dissimilar materials.

5. A manufacturing method of automated production of a plurality of prismatic single cell electrochemical devices which comprises:
providing a first dry porous electrode length then soaked with an aprotic liquid having an active material with a carbon and a polymeric binder coated on a porous metal current collector with spaced terminal tabs thereon;
providing a second dry porous electrode length then soaked with an aprotic liquid having an active material with a carbon and a polymeric binder, coated on a porous metal current collector with spaced terminal tables thereon;
providing first dry, untreated, microporous polytetrafluoroethylene separator length;
cutting said first electrode and said second electrode lengths info leafs with said terminal tabs thereon;
assembling said first electrode leafs and said second electrode leafs onto said separator length in spaced and synchronized and overlying relation;
bonding together by heat and pressure and subsequent cooling said first electrode leafs, said separator length and said second electrode leafs into a layered assembly in overlying relation, with said first separator length between said first electrode leafs and said second electrode leafs, wherein said first separator length, said first electrode leafs and said second electrode leafs are assembled in synchronized relation to form single cells layered assembly length;
winding said layered assembly length onto a spool;
or cutting said assembly length between said leafs to form individual single cells; and
drying out said aprotic liquid, stacking, electrically connecting, activating and packaging said cells.

6. A manufacturing method of automated production of a plurality of prismatic bi-cell electrochemical devices which comprises;
providing a single cells' layered assembly length as described in claim 5;
providing a third dry porous electrode length then soaked with an aprotic liquid having an active material with a carbon and a polymeric binder coated on a porous metal current collector with spaced terminal tabs thereon;
providing second dry, untreated, microporous polytetrafluoroethylene separator length;
cutting said third electrode into leafs with said terminal tabs thereon; assembling said single cells' layered assembly length and said second separator length in overlaying relation, and assembling said third electrode leafs onto said second separator length in spaced and synchronized and overlaying relation;
bonding together by heat and pressure said second electrode leafs, said second separator length and said third electrode leafs into a layered assembly in overlying relation, with said second separator length between said second electrode leafs and said third electrode leafs, wherein said second electrode leafs and said third electrode leafs, are assembled in synchronized relation to form bi-cell's layered assembly length;
winding said layered assembly length onto a spool;
or cutting said assembly length between said leafs to form individual bi-cells; and drying out said aprotic liquid, stacking, electrically connecting, activating and packaging said cells.

7. A manufacturing method of prismatic electrochemical devices as described in claims 1, or 2, or 3, or 5, or 6, in which said aprotic liquid is selected from the group consisting of gamma-butyrolactone, ethylene carbonate, butylene carbonate, N-methylpyrrolidinone, glycols, and their mixtures.

8. A manufacturing method of lithium-ion based electrochemical devices as described in claims 1, or 2, or 3, or 5, or 6, in which said binders are selected from the group consisting of polyvinylidene fluoride homo polymers, polyvinylidene fluoride hexafluoropropylene copolymers, and their alloys.

9. A manufacturing method of lithium-ion based electrochemical devices as described in claims 1, or 2, or 3, or 5, or 6, in which said bonding step included a controlled temperature and pressure, which do not cause decomposition of said separator.

10. A manufacturing method as described in claims 1, or 2, or 3, or 5, or 6, in which said bonding step includes controlled temperature and said temperature is higher than the melting point of said binders' material.

11. A manufacturing method as described in claims 1, or 2, or 3, or 5, or 6, in which said bonding step includes controlled pressure and said pressure is produced by a compliant roller.

12. A manufacturing method as described in claims 1, or 2, or 3, or 5, or 6, in which said bonding step includes controlled pressure and said pressure is produced by a complaint plate.

13. A manufacturing method as described in claims 1, or 2, or 3, or 5, or 6, in which said coated active materials with a carbon and polymeric binder are dip-coated on said metal current collectors.

14. A manufacturing method as described in claims 1, or 2, or 3, or 5, or 6, in which said porous metal col1ectors are selected from expanded metal foils, metal micro grids, metal grids, and perforated metal foils.

15. A manufacturing method as described in claims 1, or 2, or 3, or 5, or 6, in which said device is a rechargeable lithium-ion cell.

16. A manufacturing method as described in claims 1, or 2, or 3, or 5, or 6, in which said device is an electrochemical capacitor.

17. A manufacturing method as described in claims 1, or 2, or 3, or 5, or 6, in which said device is a rechargeable aqueous battery cell.

18. A structure of electrochemical devices as described in claim 4, in which said binders are selected from the group consisting of polyvinylidene fluoride homo polymers, polyvinylidene fluoride hexafluoropropylene copolymers, and their alloys.

19. A structure of electrochemical devices as described in claim 4, in which said coated active materials with a carbon and polymeric binder are dip-coated on said metal current collectors.

20. A structure of electrochemical devices as described in claim 4, in which said porous metal collectors are selected from expanded metal foils, metal micro grids, metal grids, and perforated metal foils.

21. A structure of electrochemical devices as described in claim 4, in which said device is a rechargeable lithium-ion cell.

22. A structure of electrochemical devices as described in claim 4, in which said device is an electrochemical capacitor.

23. A structure of electrochemical devices as described in claim 4, in which said device is a rechargeable aqueous battery cell.
